(19) United States
(12) Patent Application Publication
(10) Pub. No.: US 2024/0273505 A1
(43) Pub. Date: Aug. 15, 2024

(54) TERMINAL LOCATOR FOR MOBILE WALLETS

(71) Applicant: TOSHIBA GLOBAL COMMERCE SOLUTIONS, INC., DURHAM, NC (US)

(72) Inventors: RAMON A. REVERON MEDINA, TOA ALTA, PR (US); ABBY BEIZER, Raleigh, NC (US); JORDAN CASE, Honolulu, HI (US); GARY HARPER, Raleigh, NC (US)

(21) Appl. No.: 18/166,725

(22) Filed: Feb. 9, 2023

(51) Int. Cl. G06Q 20/32; G06Q 20/36

(52) U.S. Cl. CPC G06Q 20/3224; G06Q 20/327; G06Q 20/36

(57) ABSTRACT

A mobile wallet system is provided. The mobile wallet system includes a terminal and a mobile wallet on a mobile device. The mobile device includes a display. The mobile wallet locates the terminal, calculates information regarding the location of the terminal with respect to the mobile device and displays an indication on the mobile device display regarding the location information. A method is also provided.

### BACKGROUND

Recently, mobile wallets have become a popular mechanism to manage payment methods and digital passes for many users. The integration of mobile wallets into smartphones makes mobile wallets convenient, fast and in many cases more secure than the physical payment methods such as credit cards and currency.

### BRIEF DESCRIPTION OF THE SEVERAL VIEWS OF THE DRAWINGS

The present disclosure will be explained with reference to the following figures in which:

FIG. 1 is a diagram illustrating a terminal locator for a mobile wallet in a point-of-sale system in accordance with some embodiments of the present disclosure.

FIG. 2 is a diagram illustrating a terminal locator for a mobile wallet in a point-of-sale system in accordance with some embodiments of the present disclosure.

FIG. 3 is a diagram illustrating a point—of sale system in accordance with some embodiments of the present disclosure.

FIGS. 4A to 4C are diagrams illustrating locating a terminal in the point-of-sale system of FIG. 1.

FIGS. 5A to 5C are diagrams illustrating locating a terminal in the point-of-sale system of FIG. 2.

FIG. 6 is a diagram illustrating a point—of sale system in accordance with some embodiments of the present disclosure.

FIG. 7 is a diagram illustrating a venue with a terminal in accordance with some embodiments of the present disclosure.

FIG. 8 is a diagram illustrating a terminal locator for a mobile wallet in accordance with some embodiments of the present disclosure.

FIGS. 9A to 9D are diagrams illustrating locating a terminal with a mobile wallet in accordance with some embodiments of the present disclosure.

FIG. 10 is a basic block diagram of a data processor that can be used to process data provided through the mobile wallet in accordance with some embodiments of the present disclosure.

FIG. 11 is a flow diagram illustrating locating a terminal with a mobile wallet in accordance with some embodiments of the present disclosure.

### DETAILED DESCRIPTION

Exemplary embodiments of the present disclosure are described in detail with reference to the accompanying drawings. The disclosure may, however, be exemplified in many different forms and should not be construed as being limited to the specific exemplary embodiments set forth herein. Rather, these exemplary embodiments are provided so that this disclosure will be thorough and complete, and will fully convey the scope of the disclosure to those skilled in the art.

The present disclosure relates to point-of-sale systems, mobile wallets and electronic readers in general, and more particularly, to using mobile wallets for payments at self-checkout lanes or digital passes and tickets at electronic readers.

A payment process using a mobile wallet normally requires tapping the mobile device at the payment terminal or holding the mobile device near the payment terminal. Challenges may arise when a user is trying to locate the payment terminal because the location of the payment terminal varies depending on the retailer, event, check-out lanes or brand and manufacturing specifications. Locating the payment terminal in self-checkout lanes may be particularly challenging because the payment terminal may be anywhere around the customer interface screen depending on, for example, the layout, form, brand, or manufacturer.

Mobile wallets may also be used to gain entry into venues such as stadiums, concert halls, airports (boarding gates and/or security gates), museums, etc. The mobile wallet includes an electronic ticket or pass that the user accesses at electronic reader. The reader scans or reads the ticket which results in the user gaining entry to the venue. Locating the electronic terminals at entry points to the venue, for example, large venues like a stadium or airport may be challenging because there may be several entry points or gates that may or may not be equipped with electronic readers/terminals. Once arriving at the electronic reader/terminal, the user needs to position their mobile device with respect to the electronic reader/terminal interface so the reader can read the electronic ticket or digital pass. Locating the electronic reader/terminal interface may be particularly challenging because the interface may be anywhere around the electronic reader/terminal depending on, for example, the layout, form, brand, or manufacturer, and not be intuitive to the user.

The present disclosure uses a combination of GPS, Bluetooth® and ultra-wideband technologies to calculate the proximity and relative direction between the mobile device and the terminals and/or electronic readers. This information is provided to the user in real-time to help the user complete a transaction. As a user moves their mobile phone towards the terminal/reader, the display on the mobile phone will update the proximity and/or relative location of the terminal/reader in real-time with respect to the mobile device. The user will be able to ascertain if the mobile device is moving closer to the terminal/reader and where the mobile device needs to be positioned with respect to the terminal/reader in order to process or complete a transaction.

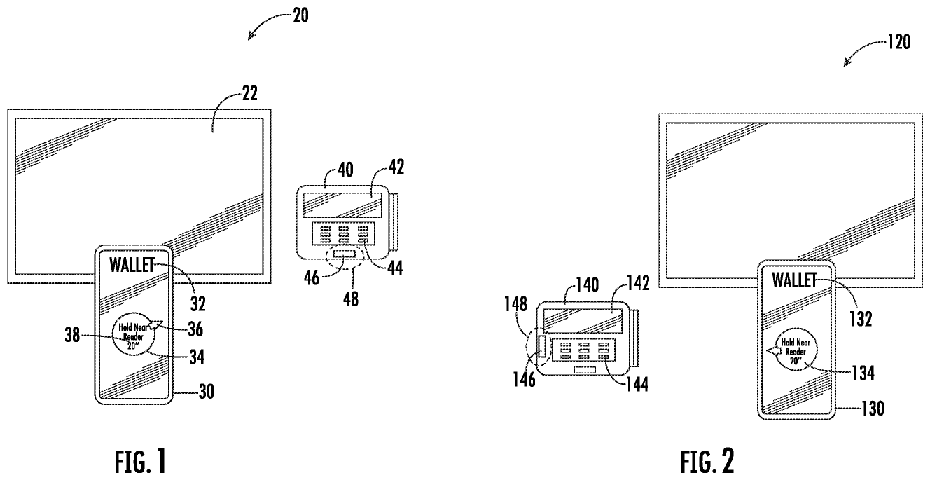

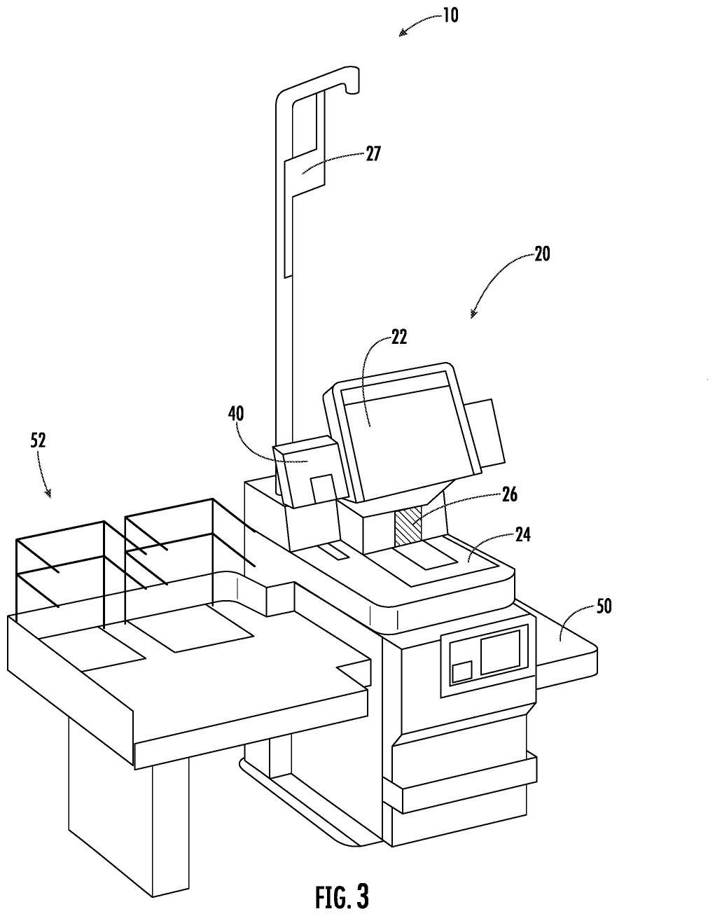

Referring first to FIG. 1, a point-of-sale (POS) system is illustrated including a console 20 including a user interface 22, payment terminal 40 and a mobile device 30. The user interface 22 may include, for example, a display and a touch screen. The payment terminal 40 may include a display 42 and a keypad 44, a beacon 46, for example, a near field communication (NFC) beacon or radio-frequency identification device (RFID) beacon 46 and a transaction zone 48. The mobile device 30 may include a mobile wallet 32 and a display 34. The payment terminal 40 is configured to accept payments, including contactless payments via the mobile device 30. As illustrated in FIG. 1A, the payment terminal 40 is to the right of the user interface 22 and the beacon 46 is centrally located below keypad 44 on terminal 40. In contrast, as illustrated in FIG. 2, a point-of-sale system including a console 120 includes a user interface 122, a payment terminal 140 located to the left and below the user interface 122 and a mobile device 130. The payment terminal 140 may include a display 142, a keypad 144 and a beacon 146, for example, a NFC beacon or RFID beacon, to the left of the keypad 144. The mobile device 130 may include a mobile wallet 132 and a display 134. The varying locations of the sensors/beacons 46, 146 and payment terminals 40, 140 within point-of-sale systems 20, 120 and the varying locations with respect to the user interface 22 may be confusing for a user and may increase the time needed for a user to complete a payment transaction.

In at least one example, a “beacon” may be any suitable hardware component that communicates with a mobile wallet to facilitate a transaction. The terminal includes suitable hardware that may be used to generate a detectable signal. The detectable signal being detectable by the mobile wallet. The hardware may be similar to the technology used in location tags, for example, Apple AirTags® and generate a Bluetooth® signal.

In at least one example, a “transaction zone” refers to the area in space in which the mobile wallet can communicate with the payment terminal or electronic reader or terminal to complete a transaction, i.e., the “transaction zone” refers to the area in space in which the mobile wallet can detect the signal emitted from the terminal. The size of the transaction zone may be related to the sensitivity of applicable hardware, for example, the beacon and mobile wallet. Transaction zones may be small because it is desirable for the user to be physically present when making the transaction, i.e., the user must be physically present at the payment terminal or electronic reader or terminal to complete the transaction.

Point-of-sale systems may include self-checkout configurations such as self-checkout lane 10 shown in FIG. 3. The self-checkout lane 10 may include a console 20, a shelf 50 for a handbasket, and a bagging station 52. The console 20 may include a customer interface, for example, a touchscreen 22, a scale 24, a scanner 26 and a payment terminal 40. An indicator 27, for example, a pole with a light attached to the top, may also be included to indicate when a customer needs the assistance of a store employee. A customer may initiate a transaction by pressing a “start” button or entering a loyalty number on the touchscreen 22. The scanner 26 may be used to scan items which are then placed in the bagging station 52. The touchscreen 22 may be used to look up items that need to be weighed, for example, produce such as melons or apples, which are weighed on the scale 24 then placed in the bagging station 52.

When a user finishes scanning items, the user may initiate payment by entering a command on the touchscreen 22. For example, the user may confirm the total amount of money owed for the items scanned and, for example, press a “Pay Now” button on the touchscreen 22 to indicate that there are no remaining items to scan and the user is ready to pay for the items. The user may want to use a form of contactless payment via their mobile wallet 32 on their mobile device 30. As used herein, a “mobile wallet” refers to a digital wallet that stores payment information or other information including, for example, electronic passes and electronic tickets, on a mobile device. Mobile wallets may include, for example, ApplePay, SamsungPay, GooglePay, Alichat and WePay. In order to pay using the mobile wallet 32, 132 the user holds their mobile device 30, 130 near the console 20, 120 as illustrated in FIGS. 1 and 2, respectively, in accordance with some embodiments of the present disclosure.

As illustrated in the embodiment of FIG. 1, the user holds the mobile device 30 near the touchscreen 22 and opens the mobile wallet 32. The user may need to authenticate the mobile wallet 32, for example, by entering a password, passcode, Touch ID or Face ID.

In accordance with some embodiments of the present disclosure, the mobile wallet 32 displays information and/or indications to facilitate and/or guide a user through the desired transaction. The indications may include information regarding where the payment terminal 40 is located with respect to the mobile device 30 and more specifically, where the transaction zone 48 is located with respect to the payment terminal 40. A user may have a challenging time finding the transaction zone 48 because, for example, the transaction zone 48 may not be labeled overtly, the user may not recognize any intended label such as an NFC icon, and the location of the transaction zone may vary with respect to the terminal depending upon the brand, design or configuration.

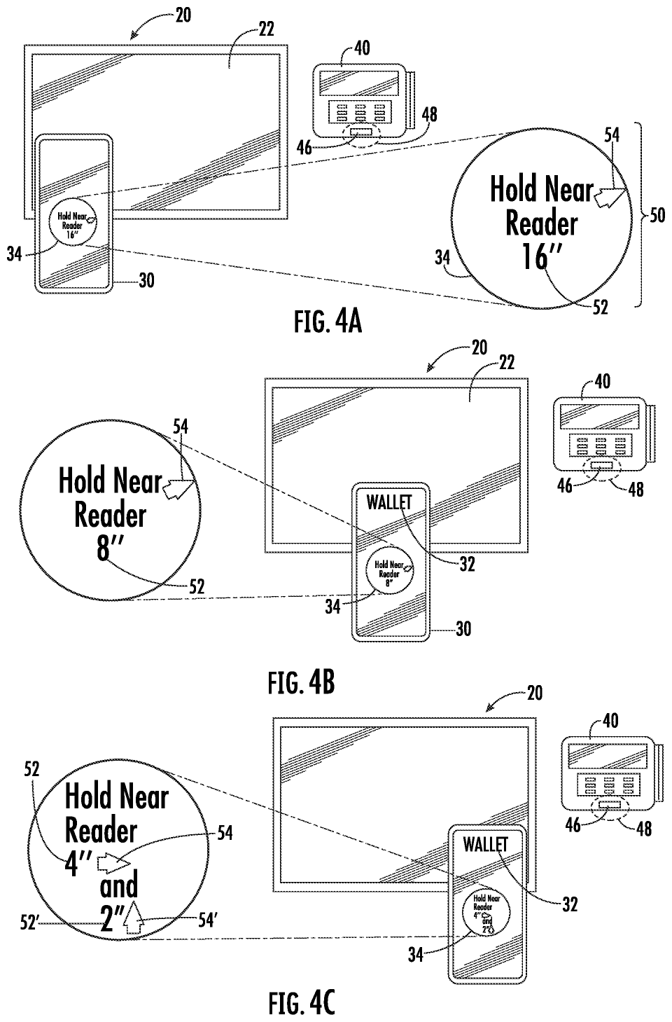

Referring now to FIGS. 4A to 4C, the mobile wallet 32 calculates indications 50, for example, a distance 52 and a direction 54 to the payment terminal 40. The mobile wallet 32 shows the distance 52 and direction 54 to the payment terminal 40 on a display 34. The direction 54 to the payment terminal 40 may be represented in words or pictorially and may include for example, an arrow 54, instructing the user which way to move their device or the direction in which the user should walk towards the payment terminal 40. The display 34 may include a single direction 54 and single distance 52 or multiple directions 54 and distances 52 as needed or desired, e.g., the display 34 may show “16 inches (52) to the right (54)” (FIG. 4A) or “4 inches (52) to the right (54) and two inches (52′) up (54′)” (FIG. 4C).

The mobile wallet 32 updates the distance 52 and direction 54 to the payment terminal 40 in real-time, i.e., as the user moves the mobile device 30 towards the payment terminal 40, the display 34 shows an updated distance 52 and updated direction 54. As illustrated in FIG. 4A, the mobile device 30 is near the left side of touchscreen 22 when the user first opens and authenticates the mobile wallet 32. After calculating the distance 52 and direction 54 to payment terminal 40, the display 34 informs the user that the payment terminal 40 is 16 inches (38) to the right using an arrow 36. As illustrated in FIG. 4B, the user moves the mobile device 30 closer to the transaction zone 48 of payment terminal 40 such that mobile wallet 32 updates the distance 38 and direction 52 to the payment terminal 40. The display 34 now informs the user that payment terminal 40 is 8 inches (52) to the right using an arrow (54). As illustrated in FIG. 4C, the mobile wallet 32 updates the distance and direction to the transaction zone 48 of payment terminal 40 again after the mobile device 30 has been moved. The display 34 informs the user that payment terminal 40 is 4 inches (52) to the right using an arrow 54 and 2 inches (52′) up using an arrow 54′.

It will be understood that embodiments of the present disclosure are discussed using arrows as indicators for the user, however, embodiments are not limited thereto. Any icon or other representation, for example, color, could be used without departing from the scope of the present disclosure.

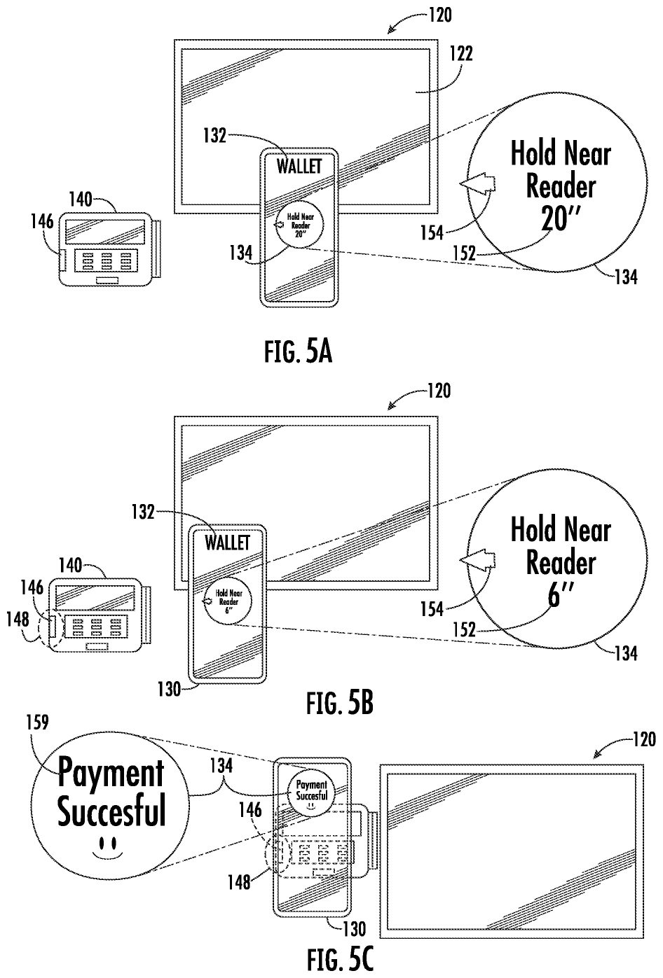

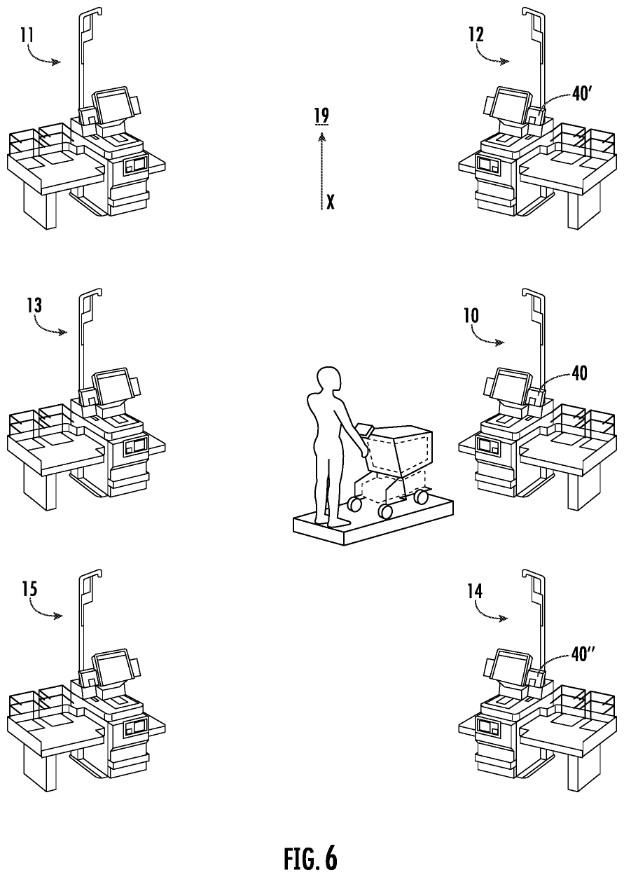

As illustrated in FIGS. 5A to 5C, a user completes a payment by moving the mobile device 130 closer to the payment terminal 140 and specifically the transaction zone 148 until the beacon 146 interacts with mobile wallet 132 to successfully complete a transaction. In FIG. 5A, a user opens and authenticates the mobile wallet 132 on their mobile device 130. The display 134 informs the user the payment terminal 140 is 120 inches to the left. The user moves the mobile device 130 closer to payment terminal 140 and as the user moves the mobile device 130, the mobile wallet 132 calculates the distance 138 and direction to the payment terminal 140 in real-time to inform the user that the payment terminal 140 is now 6 inches to the left as illustrated in FIG. 5B. The user continues to move mobile device 130 until mobile device 130 is located within the payment transaction zone 148 of payment terminal 140. Once the mobile wallet 132 is within the payment transaction zone 148 the payment may be completed. The display 134 may provide another indication 150 such as a message 159 to inform the user that the transaction is successful, e.g. “Payment Successful @” 159. Depending upon the configuration of mobile wallet 132, a user may need to reauthenticate the mobile wallet 132, select a credit card or payment type or confirm the transaction amount again prior to completing the payment transaction.

In at least one example, “real-time” includes milliseconds to a few seconds such that the mobile wallet provides the user with updates that are available virtually immediately and/or without any perceptible delay as feedback of without perceptible delay.

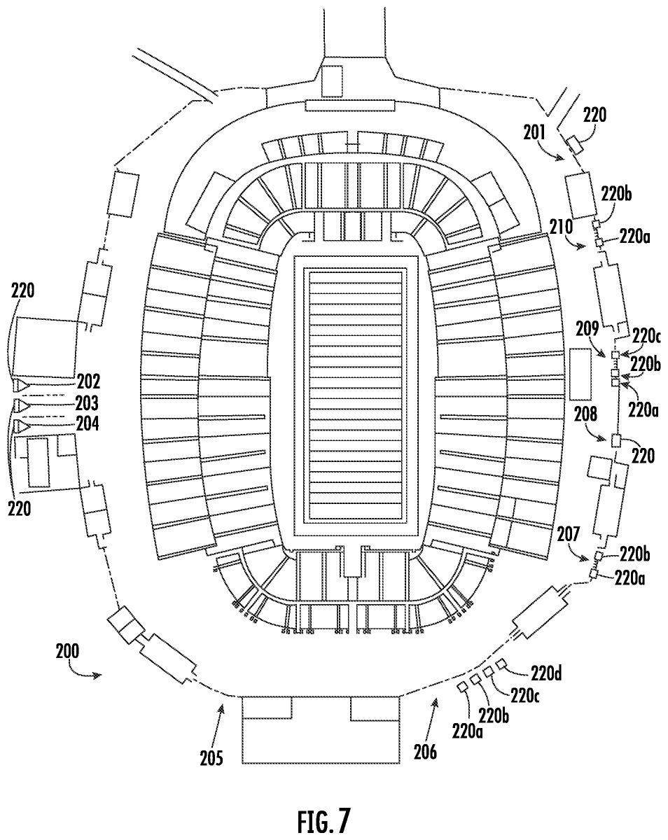

As illustrated in FIG. 6, the user and their associated mobile device 30 generally must be near the payment terminal 40 of the checkout station 10 the user is using. The transaction zone 48 is sufficiently small such that the user should not be able to make an erroneous payment via a payment terminal 40′ of an adjacent checkout station 12. As illustrated in FIG. 6, a checkout area of a retail or grocery store may include a checkout lane 19 with a plurality of checkout stations 10 to 15 in which shoppers walk through in a direction X. In accordance with some embodiments of the present disclosure, a user may open their mobile wallet 32 as the user approaches the checkout lane 19. The mobile wallet 32 locates the desired payment terminal 40 in the desired checkout station 10 to 15. For example, the user may be directed to payment terminal 40 of checkout station 10 because checkout station 10 is not occupied and operating properly. In further embodiments of the present disclosure, the user may be directed to the closest payment terminal, e.g. payment terminal 40″ of checkout station 14 as the user enters aisle 19.

In accordance with some embodiments of the present disclosure a fan or ticketholder may have a challenging time ascertaining where the fan or ticket holder can gain entry to the stadium or other venue due to the size of the venue, multiple entry points and varying configurations amongst venues. In addition, since some entry points may be designated for specific ticket holders, the fan may need to locate a specific entry point as opposed to, for example, general admission entry. Further, when using an electronic ticket the fan must ensure the entry point is equipped with an electronic reader terminal. In accordance with some embodiments of the present disclosure, the mobile wallet can provide the ticket holder with information regarding where the desired points of entry are and where the electronic reader terminals are with respect to the mobile device of the ticket holder so the ticket holder can gain entry into the stadium with their electronic ticket.

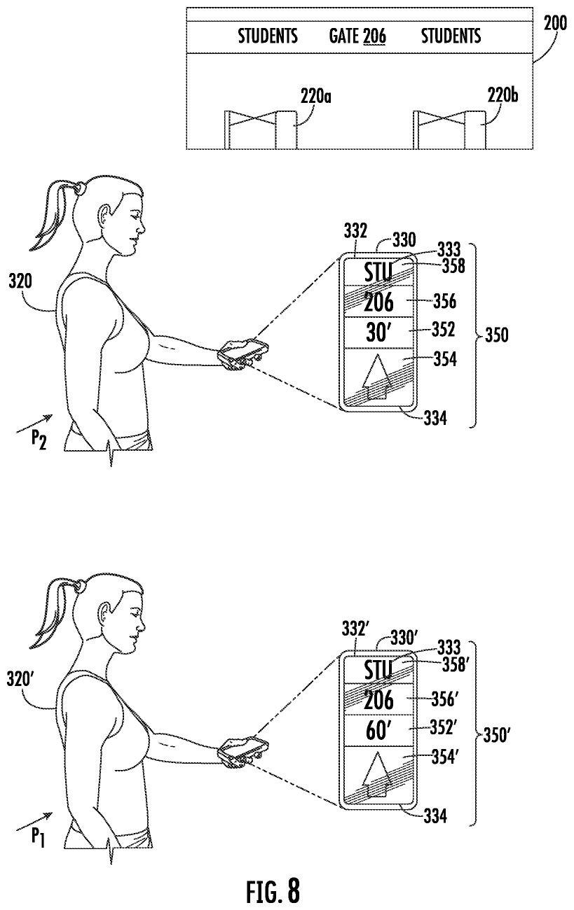

FIG. 7 a venue with a terminal in accordance with some embodiments of the present disclosure. FIG. 7 shows a stadium 200 with multiple gates 201 to 210 for entry and exit. Gates 201 to 210 may be general admission gates which can be used by all ticket holders or fans for entry and exit, and/or some or each gate 201 to 210 may accommodate specific or defined groups of ticketholders or fans, for example, gates 202, 203, 207 and 208 may be general admission gates, gate 204 may be for families, gate 205 may be for media, gate 206 may be for students, gate 209 may be handicap accessible, gate 210 may be “VIP” and/or for player guests, recruits, coaches and visiting team guests and gate 201 may be for emergency services. Some or each gate 201 to 210 may be equipped with an electronic reader terminal 220 or a plurality of electronic reader terminals 220a to 220d for reading, scanning or accepting electronic tickets or passes. It will be understood that embodiments of the present disclosure are discussed using a plurality of gates with one to four terminals at each gate, however, embodiments are not limited thereto. Any number of gates and terminals could be used without departing from the scope of the present disclosure.

Referring now to FIG. 8, a fan or ticketholder 320 with a mobile device 330 having a mobile wallet 332 may gain entry to the stadium 200 using a mobile or electronic ticket 333 or pass. Mobile wallets 332 may include, for example, ApplePay, SamsungPay, GooglePay, Alichat and WePay. The fan 320 may arrive at the stadium 200 or parking lot by public transportation, walking, drop-off or automobile. The fan 320 opens their mobile wallet 332 which may also need to be authenticated, for example, with a passcode, password, Touch ID or Face ID. The mobile wallet 332 selects and locates a desired entry gate, gate 206, or multiple gates 201 to 210 for the fan 320 to use to enter the stadium 200 with their electronic ticket 333.

Referring now to FIGS. 7 and 8, the mobile wallet 332 determines, for example, which gate 201 to 210 the ticket holder 320 should use to gain entry to stadium 200. As illustrated in FIG. 8, a student fan 320 with a student ticket 333 enters the stadium 200 via gate 206 designated for students. In some embodiments of the present disclosure, the closest gate to the mobile device may be selected, for example. In some embodiments of the present disclosure, the ticket holder may be directed to a general admission gate 202, 203, 207 and 208, VIP gate 210 or handicap accessible gate 209 when the ticket holder has a general admission, VIP or handicap accessible ticket, respectively. Gates 201 to 210 may be selected by the mobile wallet 332 based on other factors as well including, for example, crowd control and proximity to the fan or ticket holder.

The mobile wallet 332 also determines where desired gate 206 is located with respect to the mobile device 330 and displays information and indications 350 regarding where the gate 206 and electronic reader terminals 220a are located with respect to the mobile device 330. The indications 350 on display 334 serve to instruct, inform and/or guide the fan 320 to the desired gate and/or electronic terminal. The indications 350 may include information identifying the desired gate and include, for example, a gate number or gate name, street names, distance to the gate, direction to the gate, color of gate, etc. As illustrated in FIG. 8, the indications 350 include the ticket type 358 (student), gate number 356 (gate 206), a distance to the gate 352 (thirty feet) and a direction to the gate 352 (straight ahead). In some embodiments of the present disclosure, the indications may include a blinking dot representing the location of mobile device 330 and a solid dot representing the location of the gate. The direction 352 may be represented using words, icons, symbols or pictures, for example, and may include, for example, an arrow and/or a color/heat map, for guiding and instructing the fan 320 towards the gate 206. The display 334 may include single indications 350 or a group of indications as needed or desired, e.g., the display 334 may show “30 feet straight ahead” or “pass gate 205 and continue 50 feet to the left.”

The mobile wallet 332 updates the indications 350 to the gate 206 and electronic reader terminal 220a in real-time, i.e., as the fan 320 moves the mobile device 330 towards the gate 206 and electronic reader terminal 220a. The display 334 shows updated indications 350 including distances 352 and updated directions 354. As illustrated in FIG. 8, the mobile device 330′ is further from the stadium 200 when the fan 320′ first accesses the mobile wallet 332′. After calculating the first group of indications for a first location P₁, including selecting the gate 356′, distance 352′ and direction 354′ to gate 206, the display 334′ informs the fan 320′ that gate 206 is 60 feet (352′) straight ahead using an arrow 354′. As the fan 320 moves to a second location P₂ closer to the stadium 200, the mobile wallet 332 updates the distance 352 and direction 354 to gate 206. The display 334 informs the fan 320 that gate 206 is thirty feet (352) straight ahead using an arrow (354).

It will be understood that embodiments of the present disclosure are discussed using arrows as indicators for the user, however, embodiments are not limited thereto. Any icon could be used without departing from the scope of the present disclosure.

The fan 320 reaches the desired gate 206, in FIG. 8, and uses the mobile wallet 332 to gain entry to the stadium 200 with the electronic ticket 333 at the terminal 220a. The mobile wallet 332 locates and selects a terminal 220a or the fan 320 may select a terminal 220a, 220b on their own. The mobile wallet 332 updates the indications 350 including distance 354 and direction 352 to the selected terminal 220a, in real-time, i.e., as the fan 320 moves the mobile device 330 towards the terminal 220a, the display 334 shows an updated distance 354 and updated direction 354.

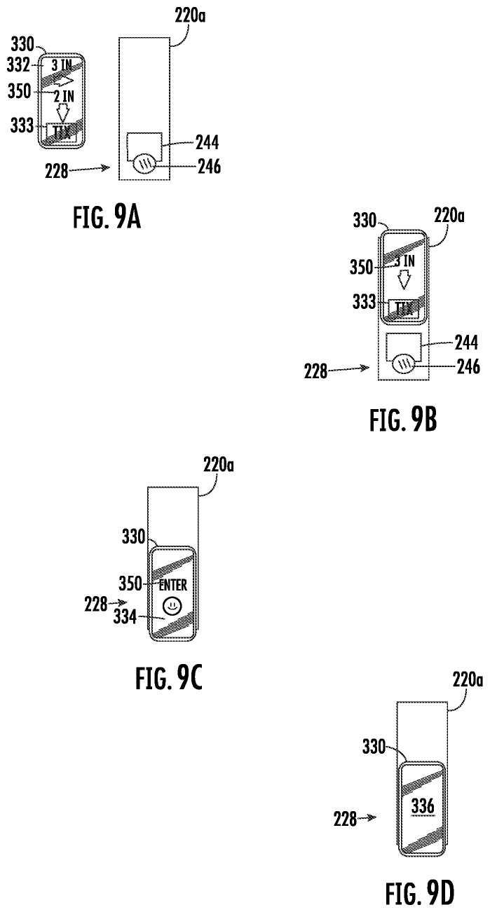

As illustrated in FIGS. 9A to 9D, a fan 320 completes the mobile wallet transaction by moving the mobile device 330 closer to the terminal 220a until the terminal 220a processes the electronic ticket 333 and admission is granted. The terminal 220a may include a transaction zone 228 having, for example, a scanner 244 to scan or read a bar code or QR code and/or a beacon 246 generating a detectable signal to be received by mobile wallet 332. Terminal 220a may include any other suitable hardware for communicating with mobile wallet 332 and the present disclosure is not limited to the examples presented herein. The mobile wallet 332 guides the mobile device 330 to the terminal 220a in a manner like that described above with respect to mobile device 130 and payment terminal 140 in FIGS. 5A to 5C. The mobile wallet 332 calculates and displays indications 350 so the fan 320 can move the mobile device 330 into the transaction zone 228 so the scanner 244 or beacon 246 can communicate with the mobile wallet 332. The indications 350 may include distance and directions to the terminal 220a and are updated in real-time. As illustrated in FIG. 9A, the indications 350 inform the user to move the mobile device 330 three inches to the right and two inches down. As shown in FIG. 9B, the updated indications 350 inform the user to move the mobile device 330 three inches down. Once the mobile wallet 332 is within the transaction zone 228; the transaction can be completed. The indications 350 on the display 334 may inform the fan 320 that the transaction is successful, e.g., “Enter” 350 as illustrated in FIG. 9C. In further embodiments of the present disclosure, the mobile device 330 may be arranged such that the display 334 faces the terminal 220a and a back 336 of the mobile device 330 faces the user. This may be desired when a scanner 224 reads or scans a bar code or QR code of the electronic ticket 333 shown on the display 334. In this example, the indications may include an instruction to turn the display 334 over once the mobile device is in the transaction zone 228.

It will be understood that embodiments of the present disclosure are discussed using a scanner, a beacon and directional arrows as examples, however, embodiments are not limited thereto. Any hardware or icon could be used without departing from the scope of the present disclosure.

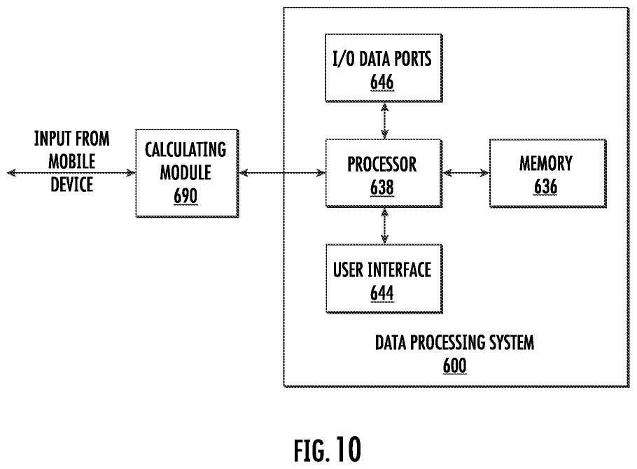

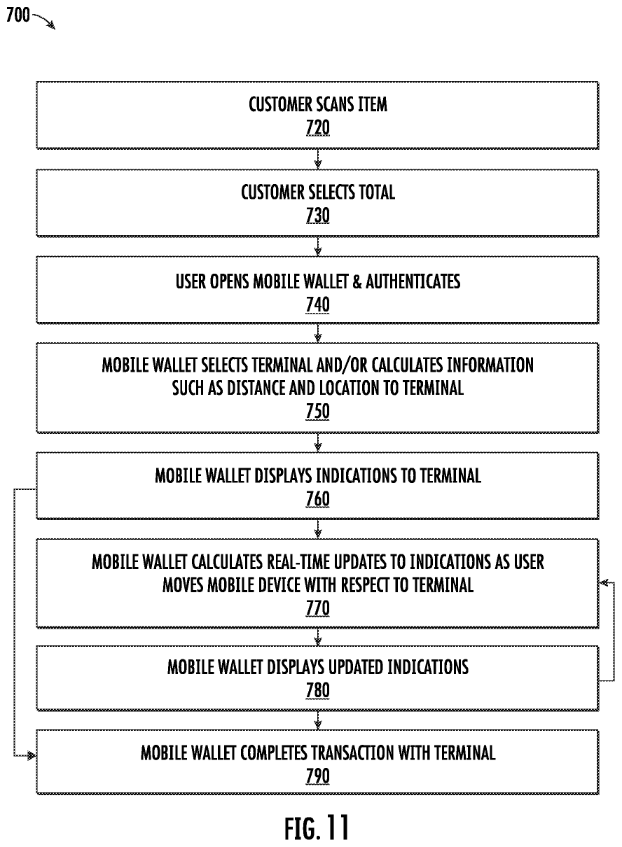

Referring now to FIG. 10, a data processor 600 in communication with a calculating module 690 that receives inputs from the mobile wallet 33, 132, 332 will be discussed. It will be understood that the data processor 600 may be included in any component of the system without departing from the scope of the present disclosure. For example, the process may be present in the mobile device 30, 130, 330 or mobile wallet 32, 132, 332. The calculating module 690 may calculate distances and/or directions and/or may determine or select gate or boarding information including gate numbers, gate names, boarding class or boarding group number and/or may determine ticket type, airline status, etc.

As illustrated, FIG. 10 is a block diagram of an example of a data processing system 600 suitable for use in the systems in accordance with embodiments of the present disclosure. The data processing may take place in mobile devices in the system without departing from the scope of the present disclosure. As illustrated in FIG. 10, the data processing system 600 includes a user interface 644 such as a keyboard, keypad, touchpad, voice activation circuit or the like, I/O data ports 646 and a memory 636 that communicates with a processor 638. The I/O data ports 646 can be used to transfer information between the data processing system 600 and another computer system or a network. These components may be conventional components, such as those used in many conventional data processing systems, which may be configured to operate as described herein.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Furthermore, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Furthermore, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C #, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Nonvolatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction.

FIG. 11 is a flow diagram illustrating a mobile wallet transaction 700 in accordance with some embodiments of the present disclosure. A user may open and authenticate a mobile wallet on their mobile device 740. The mobile wallet selects and/or locates a terminal and calculates information about the terminal, for example, information regarding the location of the terminal with respect to the mobile device 750. The mobile wallet displays indications 760 about the information which may include, for example, the distance and direction from the mobile device to the terminal so the user can move the mobile device closer to the terminal in order to continue with the transaction. The indications may also include information used to identify the terminal, particularly when, the terminal is selected from one of many terminals available. Identifying characteristics of the terminal may include name, number, location, color, etc. The mobile wallet calculates, in real-time, updates to the indications as the user moves the mobile device closer to the terminal 770 and displays these updated indications on the mobile device 780. Steps 770 and 780 are repeated until the mobile device is positioned with respect to the terminal such that the mobile wallet and terminal can complete the transaction.

The user may engage in additional optional steps during the mobile wallet transaction 700. For example, a user in a grocery store may scan items 720 at a checkout station and/or select a total 730 or “pay now” feature on a user interface of the checkout station. The user may complete these steps prior to or simultaneous with the user opening and authenticating the mobile wallet 740 or anytime thereafter until the transaction is completed.

Referring now to FIGS. 5A to 5C and FIG. 11, a user completes a mobile wallet transaction (700, FIG. 11) in a grocery store. The user approaches point—of sale system 120, scans items (720, FIG. 11) and selects a total by pushing a “Pay Now” button on touchscreen 122 (730, FIG. 11). The user opens and authenticates, if necessary, the mobile wallet 132 on their mobile device 130 (740, FIG. 11). The mobile wallet calculates information 150 about the terminal 140 including the direction 154 and distance 152 from mobile device 130 to terminal 140 (750, FIG. 11) and displays the indications (760, FIG. 11). As the user moves the mobile device 130 towards terminal 140, the mobile wallet 132 calculates real-time updates to the indications 152, 154, (770, FIG. 11) and displays the updated indications 152, 154 on the mobile device 130 (780, FIG. 11). The mobile wallet calculates, updates and displays the updated indications until the mobile wallet 132 is in the transaction zone 148 (770, 780, FIG. 11). Once the mobile wallet reaches the transaction zone 148, the payment is made, and the transaction is completed (790, FIG. 11). The user may need to authenticate or reauthenticate the mobile wallet again prior to payment.

Referring now to FIGS. 8, 9A to 9D and 11, a user completes a mobile wallet transaction (700, FIG. 11) at a venue. A fan 320 arrives at a stadium 200 and opens the mobile wallet 332 and ticket 333 on their mobile device 330 (740, FIG. 11). The mobile wallet 332′ selects an entry gate 206 and/or electronic terminal 220a and 220b and calculates and/or determines information such as ticket type 358′, gate number 356′, distance to gate 352′ and direction to gate 354′(750, FIG. 11). The mobile wallet 332′ displays indications 350′ regarding the information (760, FIG. 11). The mobile wallet 332 calculates real-time updates to the indications 350 as the user moves the mobile device 330 towards the gate 206 (770, FIG. 11) and displays the updated indications 350 (780, FIG. 11) until the mobile device 330 is within the transaction zone 228 of terminal 220a at gate 206 (770, FIG. 11). Once the mobile wallet 332 reaches the transaction zone 228, the transaction can be completed (790, FIG. 11). In this example, the transaction is completed when the fan 320 uses the electronic ticket 333 at terminal 220a for entry into the stadium 200. The user may need to authenticate or reauthenticate the mobile wallet 332 or ticket 333 again prior to entry.

As used herein, an “electronic ticket,” “digital ticket,” “electronic pass” or “digital pass” includes any type of ticket, pass, reservation, registration and/or booking that can be displayed on a mobile device. Examples of “electronic ticket,” “digital ticket,” “electronic pass” or “digital pass” may include, but are not limited to, tickets for athletic or sporting events, tickets for cultural activities including museums, dances, exhibits, concerts, shows, and performances, tickets for transportation including buses, trains airplanes, mass transportation and public transportation, and reservations including hotel, restaurant, and parking reservations.

A mobile wallet system is provided. The mobile wallet includes a terminal and a mobile wallet on a mobile device. The mobile device includes a display. The mobile wallet locates the terminal, calculates information regarding the location of the terminal with respect to the mobile device and displays an indication on the mobile device display regarding the location information.

The present disclosure provides a method for locating a terminal. The method includes accessing a mobile wallet on a mobile device, the mobile device including a display, locating a terminal, calculating information regarding the location of the terminal with respect to the mobile device, displaying an indication on the mobile device display regarding the location information and repeatedly updating the location information and indication on the mobile device display in real-time as the mobile device moves with respect to the terminal.

It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” when used herein, specify the presence of stated features, integers, steps, operations, elements, and/or components, but do not preclude the presence or addition of one or more other features, integers, steps, operations, elements, components, and/or groups thereof. Elements described as being “to” perform functions, acts and/or operations may be configured to or other structured to do so.

Unless otherwise defined, all terms (including technical and scientific terms) used herein have the same meaning as commonly understood by one of ordinary skill in the art to which various embodiments described herein belong. It will be further understood that terms used herein should be interpreted as having a meaning that is consistent with their meaning in the context of this specification and the relevant art and will not be interpreted in an idealized or overly formal sense unless expressly so defined herein.

While the foregoing is directed to aspects of the present disclosure, other and further embodiments of the disclosure may be devised without departing from the basic scope thereof, and the scope thereof is determined by the claims that follow.

What is claimed is:

1. A mobile wallet system comprising:
a terminal; and
a mobile wallet on a mobile device, the mobile device including a display, wherein the mobile wallet:
locates the terminal;
calculates information regarding the location of the terminal with respect to the mobile device; and
displays an indication on the mobile device display regarding the location information.

2. The mobile wallet system of claim 1, wherein the mobile wallet locates a transaction zone in which the mobile wallet can communicate with the terminal to process a transaction.

3. The mobile wallet system of claim 2, wherein the mobile wallet displays an indication on the mobile device display regarding the location information until the mobile wallet is in the transaction zone.

4. The mobile wallet system of claim 1, wherein the terminal includes hardware for communicating with the mobile wallet.

5. The mobile wallet system of claim 4, wherein the hardware generates a detectable signal and wherein the mobile wallet includes hardware for receiving the detectable signal from the terminal.

6. The mobile wallet system of claim 1, wherein the location information includes a distance to the terminal.

7. The mobile wallet system of claim 1, wherein the location information includes a direction to the terminal.

8. The mobile wallet system of claim 1, wherein the indication includes a distance to the terminal.

9. The mobile wallet system of claim 1, wherein the indication includes a direction to the terminal.

10. The mobile wallet system of claim 1, wherein the indication includes a direction and a distance to the terminal.

11. The mobile wallet system of claim 1, wherein the mobile wallet locates a transaction zone in which the mobile wallet can communicate with the terminal to process a transaction, wherein the mobile wallet displays an indication on the mobile device display regarding the location information until the mobile wallet is in the transaction zone and wherein the mobile wallet processes a transaction when the mobile wallet is in the transaction zone.

12. The mobile wallet system of claim 11, wherein the transaction is a payment transaction.

13. The mobile wallet system of claim 11, wherein the transaction includes an electronic ticket, digital ticket, electronic pass or digital pass.

14. The mobile wallet system of claim 11, wherein the mobile wallet repeatedly updates the location information and indication on the mobile device display in real-time as the mobile device moves with respect to the terminal.

15. A point-of-sale system comprising:
the mobile wallet system recited in claim 1.

16. A method for locating a terminal comprising:
accessing a mobile wallet on a mobile device, the mobile device including a display;
locating a terminal;
calculating information regarding the location of the terminal with respect to the mobile device;
displaying an indication on the mobile device display regarding the location information; and
repeatedly updating the location information and indication on the mobile device display in real-time as the mobile device moves with respect to the terminal.

17. The method of claim 16, further comprising:
locating a transaction zone in which the mobile wallet can communicate with the terminal to process a transaction.

18. The method of claim 17, wherein the indication is repeatedly updating until the mobile device is in the transaction zone.

19. The method of claim 16, further comprising processing a transaction when the mobile device is in the transaction zone.

20. The method of claim 16, wherein the terminal is a payment terminal or electronic reader.
